(19) United States
(12) Patent Application Publication
(10) Pub. No.: US 2010/0042987 A1
(43) Pub. Date: Feb. 18, 2010

(54) INSTALL SYSTEM THAT INSTALLS DRIVER BEST SUITED FOR CONFIGURATION OF DATA PROCESSING DEVICE

(75) Inventor: Takafumi YAMADA, Nagoya-shi (JP)

Correspondence Address: SCULLY SCOTT MURPHY & PRESSER, PC, 400 GARDEN CITY PLAZA, SUITE 300, GARDEN CITY, NY, 11530, US

(73) Assignee: BROTHER KOGYO KABUSHIKI KAISHA, Aichi-ken (JP)

(21) Appl. No.: 12/533,758

(22) Filed: Jul. 31, 2009

(30) Foreign Application Priority Data
Aug. 12, 2008 (JP) 2008-208024

(51) Int. Cl. G06F 9/445; G06F 3/00

(52) U.S. Cl. 717/174; 358/1.13; 710/10

(57) ABSTRACT

When a periphery device is brought into connection with a data processing device, the data processing device executes a driver search program stored in the periphery device and installs a driver from a registered install source. The driver search program is for registering, as the install source, either a drive of the periphery device or a drive provided to a device other than the periphery device.

### CROSS REFERENCE TO RELATED APPLICATIONS

This application claims priority from Japanese Patent Application No. 2008-208024 filed Aug. 12, 2008. The entire content of this priority application is incorporated herein by reference.

### TECHNICAL FIELD

The disclosure relates to a periphery device that becomes controllable by a data processing device upon installing a driver to the data processing device, a storage medium storing a set of program instructions for controlling the data processing device to install the driver, and a driver install system including the periphery device and the data processing device.

### BACKGROUND

There have been proposed different methods of installing a driver corresponding to a periphery device, such as a printer, to Operating System (OS) of a data processing device. In a first method, the driver is installed from such media as a flexible disk or a CD-ROM attached as an accessory to the periphery device. In a second method, on the other hand, the driver is installed, when the periphery device is brought into connection with the data processing device, from a memory of the periphery device, without using such media.

Because which one of the above-described two methods is more convenient depends on the structure of the data processing device, adopting either one of the two methods cannot fully enhance the convenience.

### SUMMARY

In view of the foregoing, it is an object of the invention to provide a technology that enables install of a driver corresponding to a periphery device to a data processing device with a method best suited for a configuration of the data processing device.

In order to attain the above and other objects, the invention provides a periphery device including a connector, a first storing unit, and a second storing unit. The connector is capable of being connected to a data processing device including an install unit and an execute unit. The install unit installs, if a driver for controlling a specific function of the periphery device is not installed when the periphery device is brought into connection with the data processing device through the connector, the driver from an install source registered in a memory area. The execute unit executes program instructions when the periphery device is brought into connection with the data processing device if the execute unit is being set to execute the program instructions when the periphery device is brought into connection with the data processing device. The second storing unit stores a set of the program instructions executable on the data processing device and usable for controlling the data processing device to execute the processing. The program instructions includes selecting one of the first storing unit and a third storing unit based on at least one predetermined condition before the install unit installs the driver, and registering the selected one of the first storing unit and the third storing unit as the install source in the memory area. The third storing unit is provided to a device other than the periphery device.

There is also provided a storage medium storing a set of program instructions executable on a data processing device for controlling the data processing device to execute a registering processing. The data processing device includes an install unit and an execute unit. The install unit installs, if a driver for controlling a specific function of a periphery device is not installed when the periphery device is brought into connection with the data processing device, the driver from an install source registered in a memory area. The execute unit executes the program instructions when the periphery device is brought into connection with the data processing device if the execute unit is being set to execute the program instructions when the periphery device is brought into connection with the data processing device. The periphery device includes a first storing unit and a second storing unit storing the set of program instructions. The program instructions includes selecting one of the first storing unit and a third storing unit based on at least one predetermined condition before the install unit installs the driver, and registering the selected one of the first storing unit and the third storing unit as the install source in the memory area. The third storing unit is provided to a device other than the periphery device.

There is also provided a driver install system including a data processing device and a periphery device. The data processing device includes a memory area, an install unit that installs, if a driver for controlling a specific function of the periphery device is not installed when the periphery device is brought into connection with the data processing device, the driver from an install source registered in the memory area, and an execute unit that executes program instructions when the periphery device is brought into connection with the data processing device if the execute unit is being set to execute the program instructions when the periphery device is brought into connection with the data processing device. The periphery device includes a first storing unit and a second storing unit that stores a set of the program instructions executable on the data processing device and usable for controlling the data processing device to execute the processing. The program instructions includes selecting one of the first storing unit and a third storing unit based on at least one predetermined condition before the install unit installs the driver, and registering the selected one of the first storing unit and the third storing unit as the install source in the memory area. The third storing unit is provided to a device other than the periphery device.

Further, there is provided a data processing device including a connector capable of being connected to a peripheral device that includes a first storing unit, a memory area, an install unit that installs a driver for controlling a specific function of the periphery device if the driver is not installed when the data processing device is brought into connection with the periphery device through the connector, and an execute unit that executes program instructions when the data processing device is brought into connection with the periphery device if the execute unit is being set to execute the program instructions when the data processing device is brought into connection with the periphery device. The install unit installs the driver from an install source registered in the memory area. In accordance with the program instructions, the execute unit selects one of the first storing unit and a second storing unit based on at least one predetermined condition and registers the selected one of the first storing unit and the second storing unit as the install source in the memory area before the install unit installs the driver. The second storing unit is provided to a device other than the periphery device.

### BRIEF DESCRIPTION OF THE DRAWINGS

The particular features and advantages of the invention as well as other objects will become apparent from the following description taken in connection with the accompanying drawings, in which:

FIG. 1 is a block diagram showing overall configuration of a driver install system including a data processing device and a periphery device according to an embodiment of the invention;

FIG. 2 is a flowchart representing a process executed in the data processing device when the periphery device is brought into connection with the data processing device via a USB cable;

FIG. 3 is a flowchart representing essential parts of the process of FIG. 2 and a process executed in the periphery device in association with the process shown in FIG. 2;

FIG. 4 is a flowchart representing a driver search process executed in the data processing device; and

FIG. 5 is a view showing a device driver install window.

### DETAILED DESCRIPTION

A driver install system 100 according to an embodiment of the invention will be described while referring to the accompanying drawings.

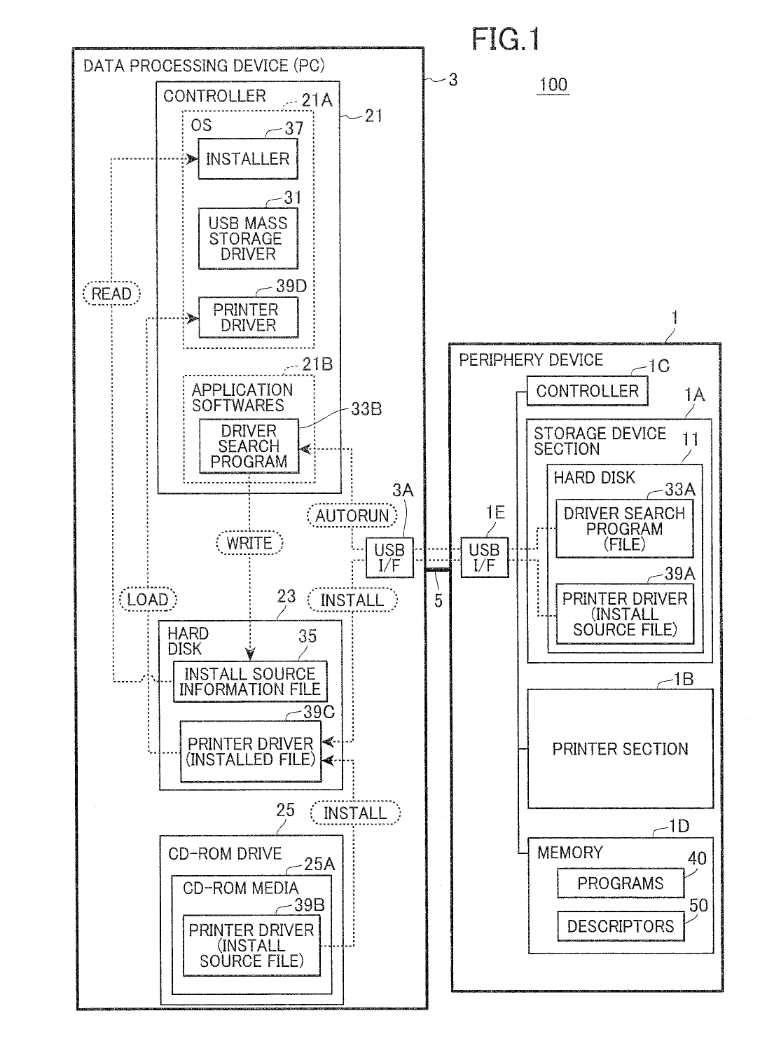

As shown in FIG. 1, the driver install system 100 includes a periphery device 1 and a data processing device 3 connected to each other via a USB cable 5.

The periphery device 1 is a USB multifunction device having a storage function and a printer function. The periphery device 1 includes a storage device section 1A providing the storage device function, a printer section 1B providing the printer function, a controller 1C, a memory 1D storing various programs 40 and descriptors 50, and a USB interface 1E.

The storage device section 1A corresponds to a single logical unit of the USB multifunction device, and includes a hard disk 11 and an input/output controller (not shown) that enables access to the hard disk 11 with a method complying with the USB standard.

The printer section 1B corresponds to a single logical unit of the USB multifunction device. Although not shown in the drawings, the printer section 1B includes an image forming mechanism for forming images on a print media, such as a sheet of paper, with an electrophotographic method or an inkjet method. The printer section 1B also includes an input/output controller (not shown) that enables access to the image forming mechanism with a method complying with the USB standard.

The controller 1C performs overall control of the periphery device 1 based on the programs 40 stored in the memory 1D.

The data processing device 3 is a personal computer (PC) and includes a controller 21, a hard disk 23, a CD-ROM drive 25, and a USB interface 3A.

The controller 21 includes hardware, such as a CPU, a ROM, and a RAM, and software that operates on the hardware. The software includes an operating system (OS) 21A and various application softwares 21B.

The OS 21A is an operating system having multitask function for parallel processing of a plurality of tasks. An example of an operating system having such a multitask function is Windows.

Since functions of this type of OS are well-known in the art, detailed description thereof will be omitted. In the following description, it is assumed that the data processing device 3 is equipped with Windows.

Next, an install method to install a printer driver for controlling the printer function of the periphery device 1 to the data processing device 3 will be briefly described.

When the periphery device 1 is brought into connection with the data processing device 3 via the USB cable 5 through the USB interfaces 1E and 3A, data is transmitted and received between the periphery device 1 and the data processing device 3 in a method complying with the USB standard. As a result, the data processing device 3 recognizes the periphery device 1 as a mass storage device.

Also, the data processing device 3 loads a USB mass storage driver 31 normally provided to the OS 21A onto a memory in the controller 21. This enables the data processing device 3 to access files in the hard disk 11 of the periphery device 1.

Then, the OS 21A retrieves autorun information from a file stored in the hard disk 11, using an autorun function normally provided to the OS 21A. The autorun information includes information to activate a driver search program 33A stored in the hard disk 11. As a result, the driver search program 33A is loaded from the hard disk 11 into the memory in the controller 21, so that a driver search program 33B is activated in the controller 21.

When the driver search program 33B is activated in this manner, the driver search program 33B executes a driver search process (described later) for searching a drive suitable as an install source from which a printer driver is installed. Information on the install source is written into an install source information file 35 in the hard disk 23. In this embodiment, as will be described later, either one of a printer driver 39A in the hard disk 11 or a printer driver 39B in a CD-ROM media 25A set in the CD-ROM drive 25 is selected, and a location of the selected printer driver 39A or 39B is stored, as the information on the install source, into the install source information file 35. In other words, either the hard disk 23 or the CD-ROM drive 25 is selected and registered as the install source in the install source information file 35. Note that in this embodiment, a pathname of the printer driver 39A or the printer driver 39B is stored as the information on the install source.

Even while the driver search process is being executed, transmission and reception of data continues between the periphery device 1 and the data processing device 3 in the method complying with the USB standard. As a result, the data processing device 3 recognizes the periphery device 1 also as a printer. Also, the OS 21A of the data processing device 3 determines whether or not a printer driver has been installed. If a printer driver has not been installed, then an installer 37 of the OS 21A is activated to execute an install process so as to install the printer driver.

When the install process starts, first the installer 37 reads information on the install source (i.e., pathname) from the install source information file 35. Then, the installer 37 installs a printer driver from a file indicated by the pathname (or a certain file in a directory indicated by the pathname). As a result, a printer driver 39C is stored into the hard disk 23 of the data processing device 3, and setting information for a printer is stored in a registry or other memory area.

The printer driver 39C installed in this manner is loaded into a memory of the controller 21 when print data is output from the data processing device 3 to the periphery device 1, so that a printer driver 39D functions in the controller 21 to output the print data to the periphery device 1.

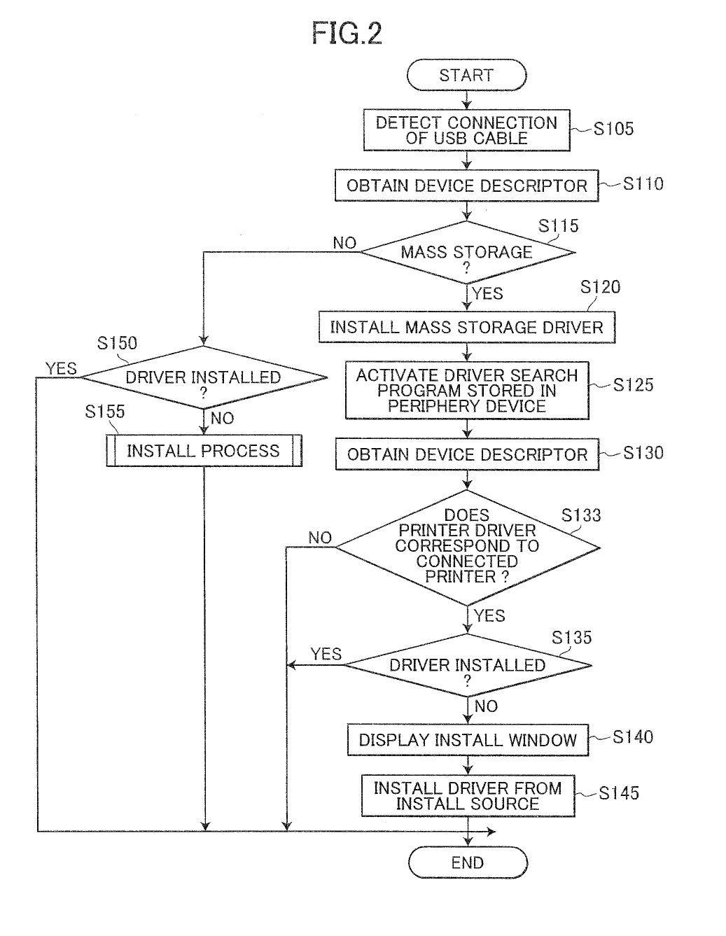

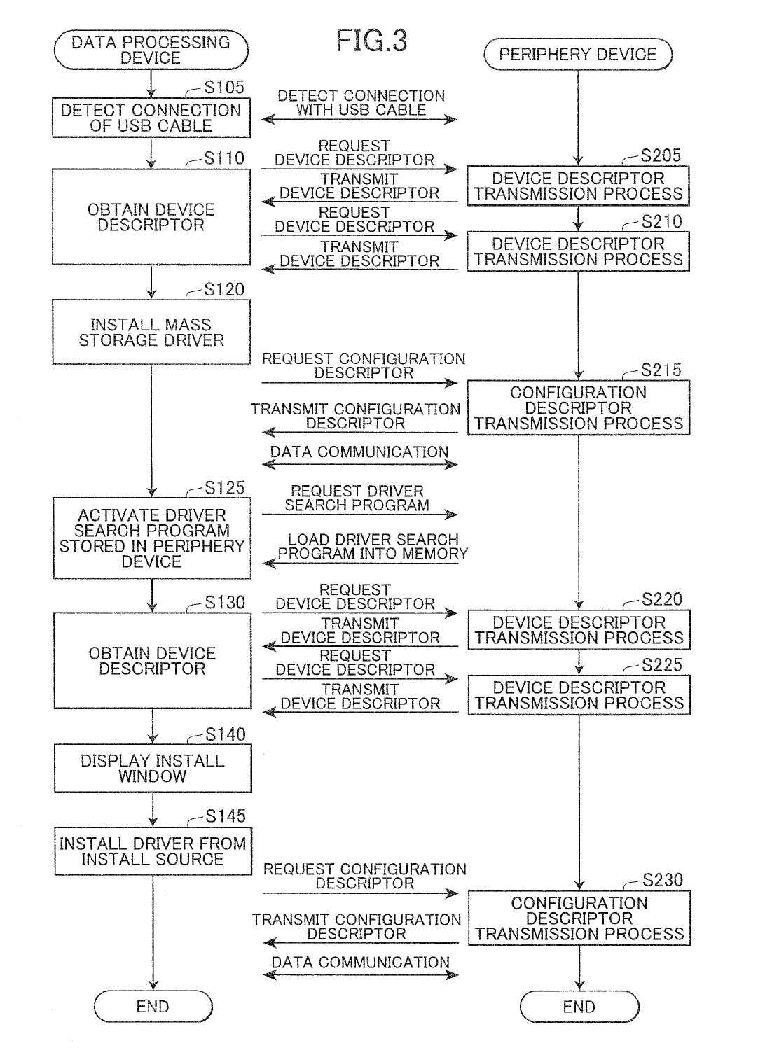

Next, processes executed in the data processing device 3 and the periphery device 1 when the periphery device 1 is brought into connection with the data processing device 3 via the USB cable 5 will be described in detail with reference to FIGS. 2 and 3. Note that these processes are executed under the control of the OS 21A or the controller 1C.

As shown in FIG. 2, when the periphery device 1 is brought into connection with the data processing device 3 via the USB cable 5, first in S105, connection of the USB cable 5 is detected. Then, in S110, a device descriptor is obtained from the periphery device 1. A device descriptor is a set of data in a certain data structure specified by the USB standard. The device descriptor includes such information as bender ID, product ID, manufacturer's name, and product name, that is required when identifying the periphery device 1.

More specifically, as shown in FIG. 3, the data processing device 3 requests in S110 a device descriptor from the periphery device 1. In response, the periphery device 1 executes in S205 a device descriptor transmission process. As a result, a device descriptor is transmitted from the periphery device 1 and received by the data processing device 3.

Receiving the device descriptor, the data processing device 3 recognizes the periphery device 1 as a device that has a logical unit complying with the USB standard, and sets a device address of the logical unit. Then, the data processing device 3 again requests a device descriptor from the periphery device 1 in S110. In response, the periphery device 1 executes in S210 the device descriptor transmission process, so that a device descriptor is again transmitted from the periphery device 1 and received by the data processing device 3. As a result, the data processing device 3 obtains various information, included in the device descriptor, relating to the logical unit of which the device address has been set.

Here, the device descriptor transmitted from the periphery device 1 to the data processing device 3 in S205 and S210 is information relating to the storage device section 1A, and the information includes information indicating that the logical unit corresponding to the storage device section 1A is a USB mass storage class device.

As shown in FIG. 2, next in S115, the data processing device 3 determines whether the type of the device is a mass storage or not.

If any device other than the periphery device 1 (a printer other than the periphery device 1, for example) is being connected to the data processing device 3, then a negative determination is made in S115 (S115:NO). In this case, it is determined in S150 whether or not a driver corresponding to the connected device has been installed. If so (S150:YES), then the process of FIG. 2 ends. On the other hand, if not (S150:NO), then an install process is executed in S155 to install a driver corresponding to the connected device, and the process shown in FIG. 2 ends.

On the other hand, if the periphery device 1 is being connected to the data processing device 3 as in this embodiment, a positive determination is made in S115 (S115:YES), because the device descriptor obtained in S110 includes the information indicating a USB mass storage class device.

Then, in S120, the data processing device 3 installs an OS standard mass storage driver. As a result, the USB mass storage driver 31 functions in the controller 21 of the data processing device 3.

As shown in FIG. 3, when the USB mass storage driver 31 functions, the data processing device 3 requests a configuration descriptor from the periphery device 1. In response, a configuration descriptor transmission process is executed in the periphery device 1 in S215, so that a configuration descriptor is transmitted from the periphery device 1 and received by the data processing device 3. A configuration descriptor is a set of data having a certain data structure specified by the USB standard. The configuration descriptor includes information on an interface and functions of the periphery device 1.

Receiving the configuration descriptor, the data processing device 3 recognizes configurations of endpoint and an interface to use when accessing the storage device section 1A, enabling data communication with the storage device section 1A.

As shown in FIG. 2, after S120, the data processing device 3 activates in S125 the driver search program 33A stored in the periphery device 1, using the autorun function of the OS 21A.

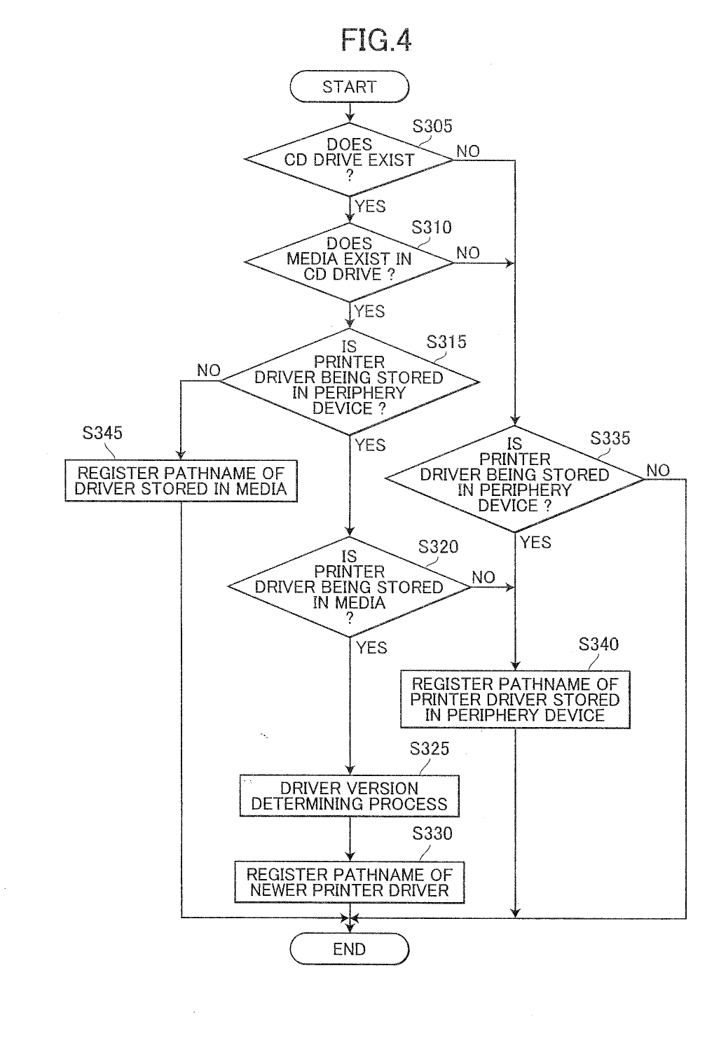

More specifically, the autorun function is a function that, if a file having a specific name exists in a route directory when the data processing device 3 recognizes a file system in the hard disk 11 and assigns a drive letter, reads autorun information from the file and execute a process based on the autorun information. In this embodiment, the data processing device 3 loads the driver search program 33A into a memory in the controller 21 based on the autorun information. As a result, the driver search program 33B functions in the controller 21. When the driver search program 33B is activated in this manner, the data processing device 3 executes the driver search process shown in FIG. 4 while continuously executing the process of FIG. 2.

Here, the driver search process will be described with reference to FIG. 4. First in S305, it is determined whether a CD drive exists or not. Because the data processing device 3 of the embodiment includes the CD-ROM drive 25 as shown in FIG. 1, a positive determination is made in S305 (S305:YES), and then it is determined in S310 whether or not a media exists in the CD drive (CD-ROM drive 25).

Because the CD-ROM media 25A is set to the CD-ROM drive 25 in this embodiment, a positive determination is made in S310 (S310:YES). Then, it is determined in S315 whether or not a printer driver (the printer driver 39A) is being stored in the periphery device 1.

If it is determined in S315 that no printer driver exists in the periphery device 1 (S315:NO), then in S345, a location (i.e., pathname) of the printer driver 39B stored in the CD-ROM media 25A is written into the install source information file 35, and the driver search program shown in FIG. 4 ends.

On the other hand, if a positive determination is made in S315 (S315:YES), then it is determined in S320 whether or not a printer driver (the printer driver 39B) corresponding to the periphery device 1 is being stored in the media (CD-ROM media 25A). More specifically, both a filename of the printer driver 39A and a filename of the printer driver 39B are obtained, and the two obtained filenames are compared. If the two filenames match, then it is determined that a printer driver of the periphery device 1 exists in the media (CD-ROM media 25A).

If a positive determination is made in S320 (S320:YES), then in S325, a driver version determining process is executed. In the driver version determining process, version information of the printer drivers 39A and 39B are obtained, and it is determined which one of the printer drivers 39A and 39B is newer version. Next in S330, a pathname of newer one of the printer drivers 39A and 39B is stored in the install source information file 35. That is, if the printer driver 39B is newer version, then a pathname of the printer driver 39B is stored in the install source information file 35. On the other hand, if the printer driver 39A is newer version, then a pathname of the printer driver 39A is stored in the install source information file 35. After the process of S330, the driver search process ends.

If a negative determination is made in S320 (S320:NO), this means that a printer driver corresponding to the periphery device 1 only exists in the periphery device 1. Thus, a pathname of the printer driver (printer driver 39A) in the periphery device 1 is stored in the install source information file 35 in S340, and then the driver search process ends.

If a negative determination is made in S305 or S310 (S305:NO or S310:NO), then the process proceeds to S335 so as to determine whether or not a printer driver exists in the periphery device 1. If so (S335:YES), meaning that a printer driver of the periphery device 1 only exists in the periphery device 1, the process proceeds to S340. On the other hand, if not (S335:NO), this means that a printer driver of the periphery device 1 exists neither in the data processing device 3 nor in the periphery device 1, and the driver search process ends.

As mentioned above, the driver search process described above is started in S125 of FIG. 2, and processes following the process in S125 of FIG. 2 are executed simultaneously with the driver search process of FIG. 4. The processes following the process of S125 will be described next.

As shown in FIG. 2, after the process of S125, the data processing device 3 obtains in S130 a device descriptor from the periphery device 1.

More specifically, as shown in FIG. 3, the data processing device 3 requests in S130 a device descriptor from the periphery device 1. In response, the periphery device 1 executes in S220 a device descriptor transmission process to transmit a device descriptor to the data processing device 3. As a result, the data processing device 3 obtains the device descriptor.

Receiving the device descriptor, the data processing device 3 recognizes the periphery device 1 as a device that has a logical unit complying with the USB standard, and sets a device address of the logical unit. Then, the data processing device 3 again requests a device descriptor from the periphery device 1, and the periphery device 1 executes in S225 the device descriptor transmission process in response to the request.

As a result, a device descriptor is again transmitted from the periphery device 1 and received by the data processing device 3. Receiving the device descriptor, the data processing device 3 obtains various information, included in the device descriptor, relating to the logical unit of which the device address has been set.

Here, the device descriptor transmitted from the periphery device 1 to the data processing device 3 in S220 and S225 is information corresponding to the printer section 1B and including information indicating that the logical unit corresponding to the printer section 1B is a printer class device.

As shown in FIG. 2, after the process of S130, it is determined in S133 whether or not the printer driver 39A or 39B registered in the install source information file 35 in S330, S340, or S345 of FIG. 4 corresponds to the printer section 1B. More specifically, based on the pathname stored in the install source information file 35, the OS 21A obtains a table that is prestored either in the hard disk 11 or the CD-ROM media 25A from a directory of the printer driver 39A or 39B. The table lists names of printers to which the printer driver (39A, 39B) corresponds. Then, the OS 21A compares the listed printer names and a printer name indicated by the device descriptor obtained in S130 so as to determine whether the printer driver 39A or 39B corresponds to the connected printer (printer section 1B). If the printer name in the device descriptor is listed on the table, then a positive determination is made in S133 (S133:YES). On the other hand, if the printer name in the device descriptor is not listed on the table, then a negative determination is made in S133 (S133:NO).

If a negative determination is made in S133 (S133:NO), then the process ends. On the other hand, if a positive determination is made in S133 (S133:YES), then the process proceeds to S135 to determine whether or not a driver of the device (logical unit) newly recognized in S130 has been installed.

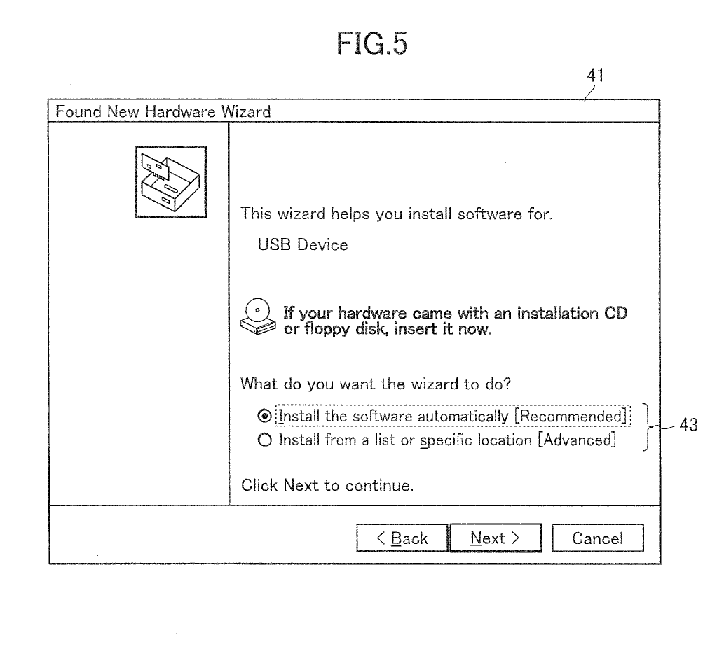

If so (S135:YES), this means that no driver needs to be installed. Therefore, the process of FIG. 2 ends. On the other hand, if not (S135:NO), then in S140, the installer 37 is activated to display an install window for a device driver. More specifically, a device driver install window 41 shown in FIG. 5 is displayed on a display unit (not shown) of the data processing device 3, enabling a user to instruct the data processing device 3 to install a device driver by selecting an install option using a radio button 43 on the device driver install window 41.

If the user selects “install the software automatically” using the radio button 43 and instructs an install to the data processing device 3, then in S145 the installer 37 installs a device driver from an install source into the hard disk 23 as the printer driver 39C.

More specifically, in S145, a pathname is retrieved from the install source information file 35, and a file indicated by the pathname (or a certain file in a directory indicated by the pathname) is used as the install source. Note that the pathname is the one that has been written in the process of S330, S340, or S345 shown in FIG. 4.

That is, the driver search process shown in FIG. 4 stared in the process of S125 completes by the time of when the process of S145 is executed, so that a pathname is stored into the install source information file 35 by the time of when the process of S145 is executed. Therefore, it is possible to retrieve a pathname of a suitable install source from the install source information file 35 in the process of S145.

In this embodiment, either the printer driver 39A or 39B is installed in S145 based on the pathname stored in the install source information file 35.

After a printer driver is installed in S145 of FIG. 2, as shown in FIG. 3, the data processing device 3 requests a configuration descriptor from the periphery device 1. In response, the periphery device 1 executes a configuration descriptor transmission process in S230.

Obtaining the configuration descriptor, the data processing device 3 recognizes configurations of an endpoint, an interface, and the like to use when accessing the printer section 1B, enabling data communication with the printer section 1B. Then, the processes shown in FIGS. 2 and 3 end.

After this, the printer driver 39D operates when the data processing device 3 outputs print data to the periphery device 1.

Note that the device descriptor transmission process and the configuration descriptor transmission process shown in FIG. 3 are executed in the periphery device 1 under the control of the controller 1C based on the programs 40 stored in the memory 1D.

As described above, according to the embodiment of the invention, when a driver for controlling a printer function of the periphery device 1 has not been installed to the data processing device 3 at the time of when the periphery device 1 is brought into connection with the data processing device 3, either one of the printer driver 39A stored in the periphery device 1 and the printer driver 39B stored in a storage device (the CD-ROM media 25A) other than the periphery device 1 is registered dynamically as an install source in the install source information file 35. Then, a driver is installed from the registered install source.

As mentioned above in the BACKGROUND section, because which one of the above-described two conventional methods is more convenient depends on the structure of the data processing device, adopting either one of the two methods cannot fully enhance the convenience.

For example, in order to utilize the first method, the data processing device needs to be able to read data from media. Therefore, if the data processing device is not provided with a hardware for reading data from a specific media, then the first method cannot be used. In this point of view, the second method seems more convenient than the first method.

However, if the data processing device is provided with a hardware for reading data from a specific media, the first method is more convenient in some regards. For example, driver replacement may be needed when a new version of driver becomes available. In this case, the driver can be upgraded easily with the first method by attaching a media storing the new version of driver to a product before shipping or distributing the media at shops.

On the other hand, utilizing the second method in this case requires replacement of contents in the memory of the periphery device. Replacement of memory contents just before shipping the periphery device as a final product may cause an extensive burden of unpacking. Also, it is often difficult to replace the memory contents at shops. In this aspect, the first method seems more convenient.

However, according to the above-described embodiment, it is possible to install a driver from an install source suitable for a configuration of the data processing device 3, such as existence or nonexistence of the CD-ROM drive 25, unlike the case where either the printer driver 39A stored in the periphery device 1 or the printer driver 39B stored in the CD-ROM media 25A has been determined beforehand as an install source.

For example, even when it is possible to use the printer driver 39A stored in the periphery device 1 as an install source, it is still possible to set the printer driver 39B stored in the CD-ROM media 25A as an install source if the printer driver 39B is more suitable (e.g. newer version) than the printer driver 39A. Therefore, when the printer driver 39B that is more suitable than the printer driver 39A stored in the periphery device 1 becomes available, then it is possible to provide the printer driver 39B to users in an easy way by, for example, attaching the CD-ROM media 25A to a product or distributing at shops, without rewriting the printer driver 39A in the periphery device 1. Rewriting the printer driver 39A may be troublesome.

Also, when the CD-ROM media 25A cannot be used for any reason, then the printer driver 39A stored in the periphery device 1 is set as an install source. Therefore, it is possible to avoid a problem that no driver is installed because the CD-ROM media 25A cannot be used when installing a driver.

There may be situations where requisite minimum of the printer driver 39A only can be stored in the periphery device 1 because of insufficient memory capacity of the hard disk 11, for example. In such cases, according to the above-described embodiment, the entire printer driver 39A can be stored in and installed from a plurality of CD-ROM media 25A or a DVD-ROM having a larger capacity, enhancing the degree of freedom of capacity.

Also, there may be provided a driver set that includes a printer driver (printer driver 39A) and accessory tools (e.g., UI extension tool and help tool) that enhance the usability of the printer driver. In this case, it is possible to install only the printer driver into the periphery device 1 while the accessory tools are stored in a CD-ROM media. One may wish to avoid troublesome install using the CD-ROM media, and the other may wish to enhance the functions even if this requires handling of the CD-ROM media. The periphery device 1 according to the embodiment can meet both of these needs.

Further, according to the above-described embodiment, the periphery device 1 makes the data processing device 3 recognize that the periphery device 1 includes the logical units that correspond to a USB mass storage device and a USB device (printer, in the above embodiment) other than the USB mass storage device. Further, when the USB mass storage device is recognized, the driver search program 33A is activated by the autorun function provided to the OS 21A. Therefore, dynamic change of an install source can be realized by using a function that is normally provided to the OS 21A or a function specified by the USB standard.

While the invention has been described in detail with reference to the above embodiment thereof, it would be apparent to those skilled in the art that various changes and modifications may be made therein without departing from the spirit of the invention.

For example, the periphery device 1 according to the above-described embodiment includes the USB mass storage device function and the printer function. However, the periphery device 1 may include a scanner function or a facsimile function instead of the printer function, as well as the USB mass storage device.

Alternatively, the periphery device 1 may include the USB mass storage device function and two or more of the printer function, the scanner function, and the facsimile function. In this case, the periphery device 1 needs to be a USB multifunctional device including as many logical units as the number of these functions.

In the above-described embodiment, the periphery device 1 includes the hard disk 11 as a hardware that functions as a USB mass storage device. However, the periphery device 1 may include a storage device other than the hard disk 11. For example, such a storage device may be a non-volatile semiconductor memory built in the periphery device 1. Alternatively, the USB mass storage device function may be realized by setting a memory card in a memory card reader/writer device provided to the periphery device 1.

In the embodiment described above, the CD-ROM drive 25 is described as the driver storage device other than the hard disk 11 provided to the periphery device 1. However, the driver storage device other than the hard disk 11 is not limited to the CD-ROM drive 25, but may be a DVD-ROM drive, a memory card reader/writer device to which a memory card can be set, or a storage device on a network.

What is claimed is:

1. A periphery device comprising:
a connector capable of being connected to a data processing device including an install unit and an execute unit, the install unit installing, if a driver for controlling a specific function of the periphery device is not installed when the periphery device is brought into connection with the data processing device through the connector, the driver from an install source registered in a memory area, the execute unit executing program instructions when the periphery device is brought into connection with the data processing device if the execute unit is being set to execute the program instructions when the periphery device is brought into connection with the data processing device;
a first storing unit; and
a second storing unit that stores a set of the program instructions executable on the data processing device and usable for controlling the data processing device to execute the processing, the program instructions including:
selecting one of the first storing unit and a third storing unit based on at least one predetermined condition before the install unit installs the driver, the third storing unit being provided to a device other than the periphery device; and
registering the selected one of the first storing unit and the third storing unit as the install source in the memory area.

2. The periphery device according to claim 1, wherein the instruction for selecting selects the third storing unit when the third storing unit is provided to the data processing device, and selects the first storing unit when the third storing unit is not provided to the data processing device, based on the at least one predetermined condition.

3. The periphery device according to claim 2, wherein the instruction for selecting selects the third storing unit when the third storing unit is provided to the data processing device and when a storing media storing the driver is freely detachably set in the third storing unit, based on the at least one predetermined condition.

4. The periphery device according to claim 3, wherein the program instructions further include determining whether a device driver stored in the storing media is the driver, and the instruction for selecting selects the third storing unit when the instruction for determining determines that the device driver is the driver, based on the at least one predetermined condition.

5. The periphery device according to claim 3, wherein the instruction for selecting selects the first storing unit when the storing media is not set in the third storing unit, based on the at least one predetermined condition.

6. The periphery device according to claim 1, wherein the instruction for selecting selects one of the first storing unit and the third storing unit which stores a newer version of the driver, based on the at least one predetermined condition.

7. The periphery device according to claim 1, wherein the instruction for selecting selects the first storing unit when the driver is not stored in the third storing unit, based on the at least one predetermined condition.

8. The periphery device according to claim 1, wherein the instruction for registering registers the selected one of the first storing unit and the third storing unit by storing a pathname of the driver stored in the selected one of the first storing unit and the third storing unit into the memory area which the install unit is capable of referring to.

9. The periphery device according to claim 1, further comprising transmitting unit that transmits a first information to the data processing device in response to a first inquiry transmitted from the data processing device when the data processing device is brought into connection with the connector, the information indicating a USB mass storage device, making the data processing device recognize a storage function corresponding to both the first storage unit and the second storage unit, wherein the connector is a USB interface, and the program instructions are executed by the execute unit when the storage function is recognized by the data processing device.

10. The periphery device according to claim 9, wherein the transmitting unit transmits a second information to the data processing device in response to a second inquiry transmitted from the data processing device after the first information, the second information indicating a USB device other than the USB mass storage device, making the data processing device recognize a necessity of a driver for controlling a specified function of the USB device, encouraging the install unit to install the driver.

11. A storage medium storing a set of program instructions executable on a data processing device for controlling the data processing device to execute a registering processing, the data processing device including an install unit that installs, if a driver for controlling a specific function of a periphery device is not installed when the periphery device is brought into connection with the data processing device, the driver from an install source registered in a memory area and an execute unit that executes the program instructions when the periphery device is brought into connection with the data processing device if the execute unit is being set to execute the program instructions when the periphery device is brought into connection with the data processing device, the periphery device including a first storing unit and a second storing unit storing the set of program instructions, the program instructions comprising:
selecting one of the first storing unit and a third storing unit based on at least one predetermined condition before the install unit installs the driver, the third storing unit being provided to a device other than the periphery device; and
registering the selected one of the first storing unit and the third storing unit as the install source in the memory area.

12. A driver install system comprising:
a data processing device; and
a periphery device, wherein;
the data processing device includes:
a memory area;
an install unit that installs, if a driver for controlling a specific function of the periphery device is not installed when the periphery device is brought into connection with the data processing device, the driver from an install source registered in the memory area; and
an execute unit that executes program instructions when the periphery device is brought into connection with the data processing device if the execute unit is being set to execute the program instructions when the periphery device is brought into connection with the data processing device; and
the periphery device includes:
a first storing unit; and
a second storing unit that stores a set of the program instructions executable on the data processing device and usable for controlling the data processing device to execute the processing, the program instructions including:
selecting one of the first storing unit and a third storing unit based on at least one predetermined condition before the install unit installs the driver, the third storing unit being provided to a device other than the periphery device; and
registering the selected one of the first storing unit and the third storing unit as the install source in the memory area.

13. A data processing device comprising:
a connector capable of being connected to a peripheral device that includes a first storing unit;
a memory area;
an install unit that installs a driver for controlling a specific function of the periphery device if the driver is not installed when the data processing device is brought into connection with the periphery device through the connector, the install unit installing the driver from an install source registered in the memory area; and
an execute unit that executes program instructions when the data processing device is brought into connection with the periphery device if the execute unit is being set to execute the program instructions when the data processing device is brought into connection with the periphery device, wherein in accordance with the program instructions, the execute unit selects one of the first storing unit and a second storing unit based on at least one predetermined condition and registers the selected one of the first storing unit and the second storing unit as the install source in the memory area before the install unit installs the driver, the second storing unit being provided to a device other than the periphery device.
